(19) United States
(12) Patent Application Publication
(10) Pub. No.: US 2018/0307318 A1
(43) Pub. Date: Oct. 25, 2018

(54) GESTURE EMBEDDED VIDEO

(71) Applicants: Chia Chuan WU, Butterworth (MY); Charmaine Rui Qin CHAN, Tanjung Bungah (MY); Nyuk Kin Yuki KOO, Serumpun, Bukit Mertajam (MY); Hooi Min TAN, Gelugor (MY); INTEL CORPORATION, Santa Clara, CA (US)

(72) Inventors: Chia Chuan Wu, Butterworth (MY); Charmaine Rui Qin CHAN, Tanjung Bungah, (MY); Nyuk Kin KOO, Bukit Mertajam (MY); Hooi Min TAN, Gelugor (MY)

(21) Appl. No.: 15/531,300

(22) PCT Filed: Jun. 28, 2016
(86) PCT No.: PCT/US2016/039791

§ 371 Date: May 26, 2017

(51) Int. Cl. G06F 3/01; H04N 21/234; H04N 21/422; H04N 21/442

(52) U.S. Cl. CPC G06F 3/017; H04N 21/234; G06F 3/014; H04N 21/44213; H04N 21/422

(57) ABSTRACT

System and techniques for gesture embedded video are described herein. A video stream may be obtained by a receiver. A sensor may be measured to obtain a sample set from which a gesture may be determined to have occurred at a particular time. A representation of the gesture and the time may be embedded in an encoded video of the video stream.

### TECHNICAL FIELD

Embodiments described herein generally relate to digital video encoding and more specifically to gesture embedded video.

### BACKGROUND

Video cameras generally include a light collector and an encoding for light collection during sample periods. For example, a traditional film-based camera may define the sample period based on the length of time a frame of film (e.g., encoding) is exposed to light directed by the camera's optics. Digital video cameras use a light collector that generally measures the amount of light received at a particular portion of a detector. The counts are established over a sample period, at which point they are used to establish an image. A collection of images represents the video. Generally, however, the raw images undergo further processing (e.g., compression, white-balancing, etc.) prior to be packaged as video. The result of this further processing is encoded video.

Gestures are physical motions typically performed by a user and recognizable by a computing system. Gestures are generally used to provide users with additional input mechanisms to devices. Example gestures include pinching on a screen to zoom out of an interface or swiping to remove an object from a user interface.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A and 1B illustrate an environment including a system for gesture embedded video, according to an embodiment.

FIG. 2 illustrates a block diagram of an example of a device to implement gesture embedded video, according to an embodiment.

FIG. 3 illustrates an example of a data structure to encode gesture data with a video, according to an embodiment.

FIG. 4 illustrates an example of an interaction between devices to encode gestures into video, according to an embodiment.

FIG. 5 illustrates an example of marking points in encoded video with gestures, according to an embodiment.

FIG. 6 illustrates an example of using gestures with gesture embedded video as a user interface, according to an embodiment.

FIG. 7 illustrates an example of metadata per-frame encoding of gesture data in encoded video, according to an embodiment.

FIG. 8 illustrates an example life cycle of using gestures with gesture embedded video, according to an embodiment.

FIG. 9 illustrates an example of a method to embed gestures in video, according to an embodiment.

FIG. 10 illustrates an example of a method to add gestures to a repertoire of available gestures to embed during the creation of gesture embedded video, according to an embodiment.

FIG. 11 illustrates an example of a method to add gestures to video, according to an embodiment.

FIG. 12 illustrates an example of a method to use gestures embedded in video as a user interface element, according to an embodiment.

FIG. 13 is a block diagram illustrating an example of a machine upon which one or more embodiments may be implemented.

### DETAILED DESCRIPTION

An emerging camera form factor is a body worn (e.g., point-of-view) camera. These devices tend to be small and designed to be worn to record events such as a skiing run, an arrest, etc. Body worn cameras have allowed users to capture different perspectives of their activities, bringing the personal camera experience to a whole new level. For example, body worn cameras are able to film a user's perspective during extreme sports, during a vacation trip, etc., without impacting the user's ability to enjoy or execute these activities. However, as convenient as the ability to capture these personal videos has become, there remain some issues. For example, the length of video footage shot in this way tends to be long, with a high percentage of the footage simply being uninteresting. This issue arises because, in many situations, users tend to turn on the camera and begin recording so as to avoid missing any part of an event or activity. Generally, users rarely shut the camera off or press stop during an activity because it may be dangerous or inconvenient to, for example, take one's hand off of a cliff face while climbing to press the start recording or stop recording button on the camera. Thus, users tend to let the camera run until end of the activity, until the camera battery runs out, or until the camera's storage is filled.

The generally poor ratio of interesting footage to uninteresting footage may also make it difficult to edit the video. Due to the length of many videos taken by the camera, it may be a tedious process to re-watch and identify interesting scenes (e.g., segments, snippets, etc.) from the video. This may be problematic if, for example, a police officer records twelve hours of video only to have to watch twelve hours of video to identify any episodes of interest.

Although some devices include a bookmark feature, such as a button, to mark a spot in the video, this has a similar problem to just stopping and starting the camera, namely it may be inconvenient, or downright dangerous, to use during an activity.

The following are three use scenarios in which the current techniques for marking video are problematic. The extreme (or any) sports participant (e.g., snowboarding, skydiving, surfing, skateboarding, etc.). It is difficult for extreme sports participants to press any button on the camera, much less the bookmark button, when they are in action. Further, for these activities, the user would usually just film the whole duration of the activity from the beginning till the end. This possibly long duration of footage may make it difficult to re-watch when searching for specific tricks or stunts that they did.

Law enforcement officers. It is more common for law enforcement to wear cameras during their shifts to, for example increase their own safety and accountability as well as that of the public. For example, when the officer is in pursuit of a suspect, the whole event may be filmed and referred to later for evidentiary purposes. Again, the duration of these films is likely long (e.g., the length of a shift) but the interesting moments likely short. Not only would re-reviewing the footage likely be tedious, but at eight plus hours for each shift, the task may be prohibitive in terms of money or hours, resulting in much footage being ignored.

Medical professionals (e.g., nurses, doctors, etc.). Medical doctors may use body worn or similar cameras during surgery, for example, to film a procedure. This may be done to produce learning material, document the circumstances of the procedure for liability, etc. A surgery may last for several hours and encompass a variety of procedures. Organizing or labeling segments of the video surgery for later reference may require an expert to discem what is happening at any given moment, thus increasing costs on the producer.

To address the issues noted above and other issues as are apparent based on the present disclosure, the systems and techniques described herein simplify the marking of video segments while video is being shot. This is accomplished by eschewing the bookmark button, or similar interfaces, and instead using predefined action gestures to mark video features (e.g., frames, times, segments, scenes, etc.) during filming. Gestures may be captured in a variety of ways, including using a smart wearable device, such as a wrist worn device with sensors to establish a pattern of motion. Users may predefine action gestures recognizable by the system to start and end the bookmark feature when they start filming using their camera.

In addition to using gestures to mark video features, the gesture, or a representation of the gesture, is stored along with the video. This allows users to repeat the same action gesture during video editing or playback to navigate to bookmarks. Thus, different gestures used during filming for different video segments are also re-used to find those respective segments later during video editing or playback.

To store the gesture representation in the video, the encoded video includes additional metadata for the gesture. This metadata is particularly useful in video because understanding the meaning of video content is generally difficult for current artificial intelligence, but enhancing the ability to search through video is important. By adding action gesture metadata to the video itself, another technique to search and use video is added.

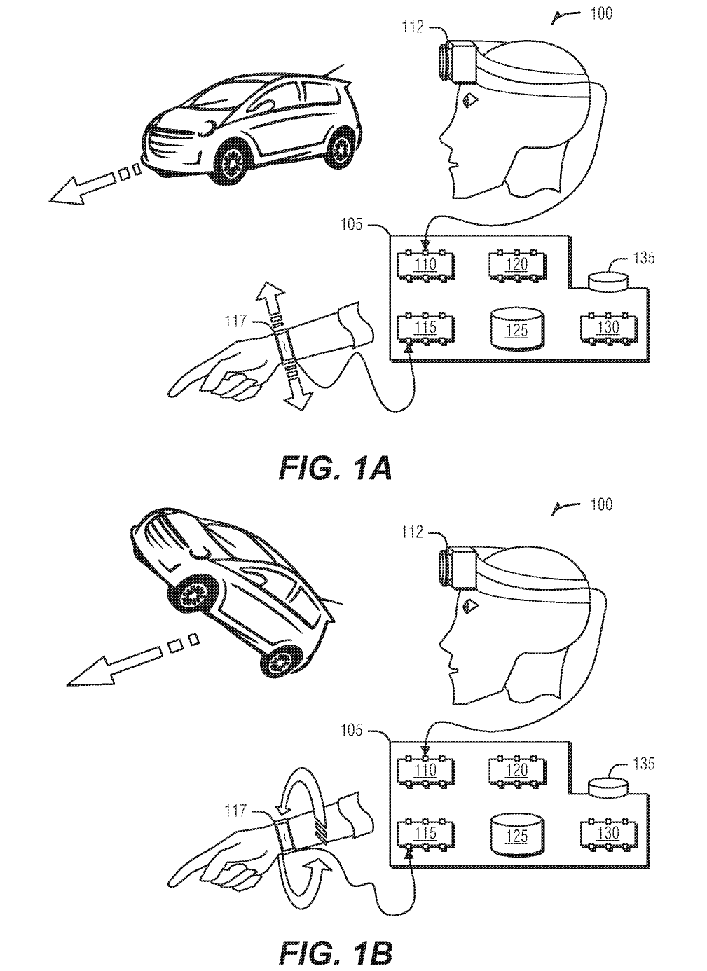

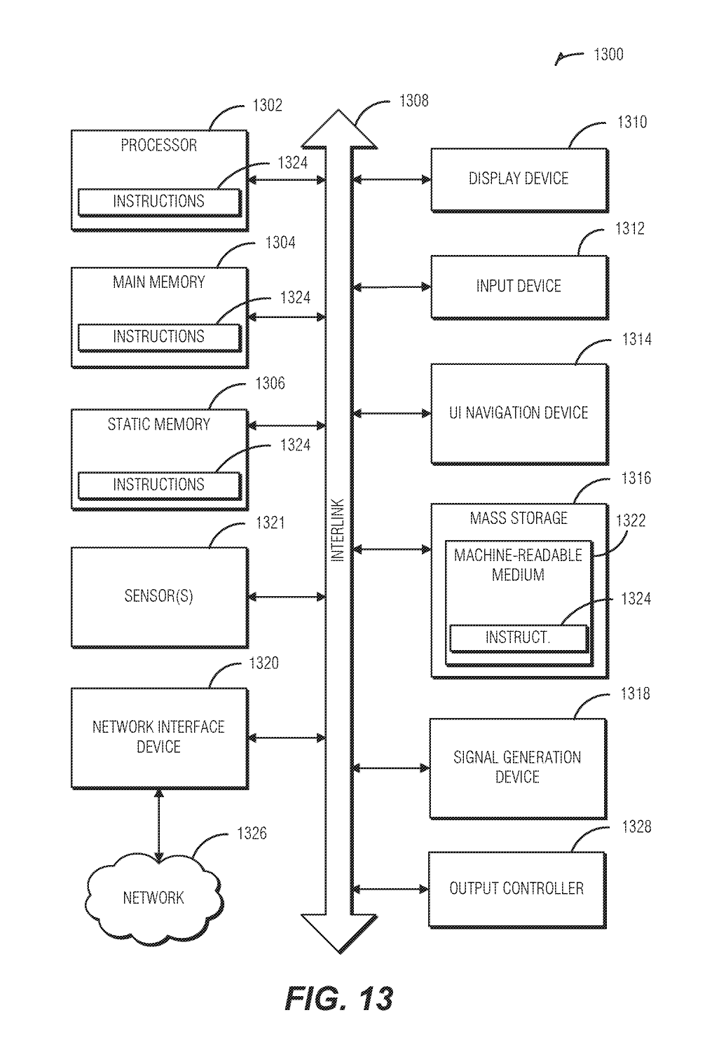

FIGS. 1A and 1B illustrate an environment 100 including a system 105 for gesture embedded video, according to an embodiment. The system 105 may include a receiver 110, a sensor 115, an encoder 120, and a storage device 125. The system 105 may optionally include a user interface 135 and a trainer 130. The components of the system 105 are implemented in computer hardware, such as that described below with respect to FIG. 13 (e.g., circuitry). FIG. 1A illustrates a user signaling an event (e.g., car accelerating) with a first gesture (e.g., an up and down motion) and FIG. 1B illustrates the user signaling a second event (e.g., car “popping a wheelie”) with a second gesture (e.g., a circular motion in a plane perpendicular to the arm).

The receiver 110 is arranged to obtain (e.g., receive or retrieve) a video stream. As used herein, a video stream is a sequence of images. The receiver 110 may operate on a wired (e.g., universal serial bus) or wireless (e.g., IEEE 802.15.*) physical link to, for example, a camera 112. In an example, the device 105 is a part of, contained within the housing of, or otherwise integrated into the camera 112.

The sensor 115 is arranged to obtain a sample set. As illustrated, the sensor 115 is an interface to a wrist worn device 117. In this example, the sensor 115 is arranged to interface with sensors on the wrist worn device 117 to obtain the sample set. In an example, the sensor 115 is integrated into the wrist worn device 117 and provides sensors or interfaces directly with local sensors, the sensor 115 communicating to other components of the system 105 via a wired or wireless connection.

The members of the sample set constitute a gesture. That is, if a gesture is recognized as a particular sequence of accelerometer readings, the sample set includes that sequence of readings. Further, the sample set corresponds to a time relative to the video stream. Thus, the sample set allows the system 105 to both identify which gesture was performed, and also the time when that gesture was performed. The time may be simply the time of arrival (e.g., correlating the sample set to a current video frame when the sample set is received) or timestamped for correlation to the video stream.

In an example, the sensor 115 is at least one of an accelerometer or a gyrometer. In an example, the sensor 115 sensor is in a first housing for a first device, and the receiver 110 and the encoder 120 are in a second housing for a second device. Thus, the sensor 115 is remote (in a different device) than the other components, such as being in the wrist worn device 117 while the other components are in the camera 112. In these examples, the first device is communicatively coupled to the second device when both devices are in operation.

The encoder 120 is arranged to embed a representation of the gesture and the time in an encoded video of the video stream. Thus, the gesture used is actually encoded into the video itself. The representation of the gesture may be different that the sample set, however. In an example, the representation of the gesture is a normalized version of the sample set. In this example, the sample set may be scaled, subject to noise reduction, etc., to normalize it. In an example, the representation of the gesture is a quantization of the members of the sample set. In this example, the sample set may be reduced, as may typically occur in compression, to a predefined set of values. Again, this may reduce storage costs and may also allow the gesture recognition to work more consistently across a variety of hardware (e.g., as between the recording device 105 and a playback device).

In an example, the representation of the gesture is a label. In this example, the sample set may correspond to one of a limited number of acceptable gestures. In this case, these gestures may be labeled, such as “circular, “up and down,” side to side,” etc. In an example, the representation of the gesture may be an index. In this example, the index refers to a table in which gesture characteristics may be found. Using an index may allow for gestures to be efficiently embedded in metadata for individual frames while storing corresponding sensor set data in the video, as a whole, once. The label variance is a type of index in which the lookup is predetermined between different devices.

In an example, the representation of the gesture may be model. Here, a model refers to a device arrangement that is used to recognize the gesture. For example, the model may be an artificial neural network with a defined input set. The decoding device may take the model form the video and simply feed its raw sensor data into the model, the output producing an indication of the gesture. In an example, the model includes an input definition that provides sensor parameters for the model. In an example, the model is arranged to provide a true or false output to signal whether the values for the input parameters represent the gesture.

In an example, embedding the representation of the gesture and the time includes adding a metadata data structure to the encoded video. Here, the metadata data structure is distinct form other data structures of the video. Thus, another data structure of the video codec, for example, is not simply re-tasked for this purpose. In an example, the metadata data structure is a table with the representation of the gesture indicated in a first column and a corresponding time in a second column of the same row. That is, the metadata structure correlates a gesture to a time. This is what may traditionally that of as a bookmark with regard to video. In an example, the table includes a start and an end time in each row. Although this is still call a bookmark herein, the gesture entry defines a segment of time rather than simply a point in time. In an example, a row has a single gesture entry and more than two time entries or time segments. This may facilitate compression of multiple distinct gestures uses in the same video by not repeating what may be a non-trivial size of the representation of the gesture. In this example, the gesture entry may be unique (e.g., not repeated in the data structure).

In an example, the representation of the gesture may be embedded directly into a video frame. In this example, one or more frames may be tagged with the gesture for later identification. For example, if a point in time bookmark is used, each time the gesture is obtained, the corresponding video frame is tagged with the representation of the gesture. If the time segment bookmark is used, a first instance of the gesture will provide the first video frame in a sequence and a second instance of the gesture will provide a last video frame in the sequence; the metadata may then be applied to every frame in the sequence include and between the first frame and the last frame. By distributing the representation of the gesture to the frames themselves, the survivability of the gesture tagging may be greater than storing the metadata in a single place in the video, such as a header.

The storage device 125 may store the encoded video before it is retrieved or sent to another entity. The storage device 125 may also store the predefined gesture information used to recognize when the sample set corresponds to such a “bookmarking” gesture. While one or more such gestures may be manufactured into the device 105, greater flexibility, and thus user enjoyment, may be achieved by allowing the user to add additional gestures. To this end, the system 105 may include a user interface 136 and a trainer 130. The user interface 135 is arranged to receive indication of a training set for a new gesture. As illustrated, the user interface 135 is a button. The user may press this button and signal to the system 105 that the sample sets being received identify a new gesture as opposed to marking a video stream. Other user interfaces are possible, such as a dial, touchscreen, voice activation, etc.

Once the system 105 is signaled about the training data, the trainer 130 is arranged to create a representation of a second gesture based on the training set. Here, the training set is a sample set obtained during activation of the user interface 135. Thus, the sensor 115 obtains the training set in response to receipt of the indication from the user interface 135. In an example, a library of gesture representations is encoded in the encoded video. In this example, the library includes the gesture and the new gesture. In an example, the library includes a gesture that does not have a corresponding time in the encoded video. Thus, the library may be unabridged even if a known gesture was not used. In an example, the library is abridged before being included into the video. In this example, the library is pruned to remove gestures that are not used to bookmark the video. The inclusion of the library allows completely customized gestures for users without the variety of recording and playback devices knowing about these gestures ahead of time. Thus, users may use what they are comfortable with and manufacturers do not need to waste resources keeping a large variety of gestures in their devices.

Although not illustrated, the system 105 may also include a decoder, comparator, and a player. However, these components may also be included in a second system or device (e.g., a television, set-top-box, etc.). These features allow the video to be navigated (e.g., searched) using the embedded gestures.

The decoder is arranged to extract the representation of the gesture and the time from the encoded video. In an example, extracting the time may include simply locating the gesture in a frame, the frame having an associated time. In an example, the gesture is one of a plurality of different gestures in the encoded video. Thus, if two different gestures are used to mark the video, both gestures may be used in this navigation.

The comparator is arranged to match the representation of the gesture to a second sample set obtained during rendering of the video stream. The second sample set is simply a sample set captured at a time after video capture, such as during editing or other playback. In an example, the comparator implements the representation of the gesture (e.g., when it is a model) as its comparison performance (e.g., implement the model and apply the second sample set).

The player is arranged to render the video stream from the encoded video at the time in response to the match from the comparator. Thus, if the time is retrieved form metadata in the video's header (or footer), the video will be played at the time index retrieved. However, if the representation of the gesture is embedded in the video frames, the player may advance, frame by frame, until the comparator finds the match and begin playing there.

In an example, the gesture is one of a plurality of the same representation of the gesture encoded in the video. Thus, the same gesture may be used to bookend a segment or to indicate multiple segments or point in time bookmarks. To facilitate this action, the system 105 may include a counter to track a number of times an equivalent of the second sample set was obtained (e.g., how many times the same gesture was provided during playback). The payer may use the count to select an appropriate time in the video. For example, if the gesture was used to mark three points in the video, the first time the user performs the gesture during playback causes the player to select the time index corresponding to the first use of the gesture in the video and the counter is incremented. If the user performs the gesture again, the player finds the instance of the gesture in the video that corresponds to the counter (e.g., the second instance in this case).

The system 105 provides a flexible, intuitive, and efficient mechanism to allow users to tag, or bookmark, video without endangering themselves or impairing their enjoyment of an activity. Additional details and examples are provided below.

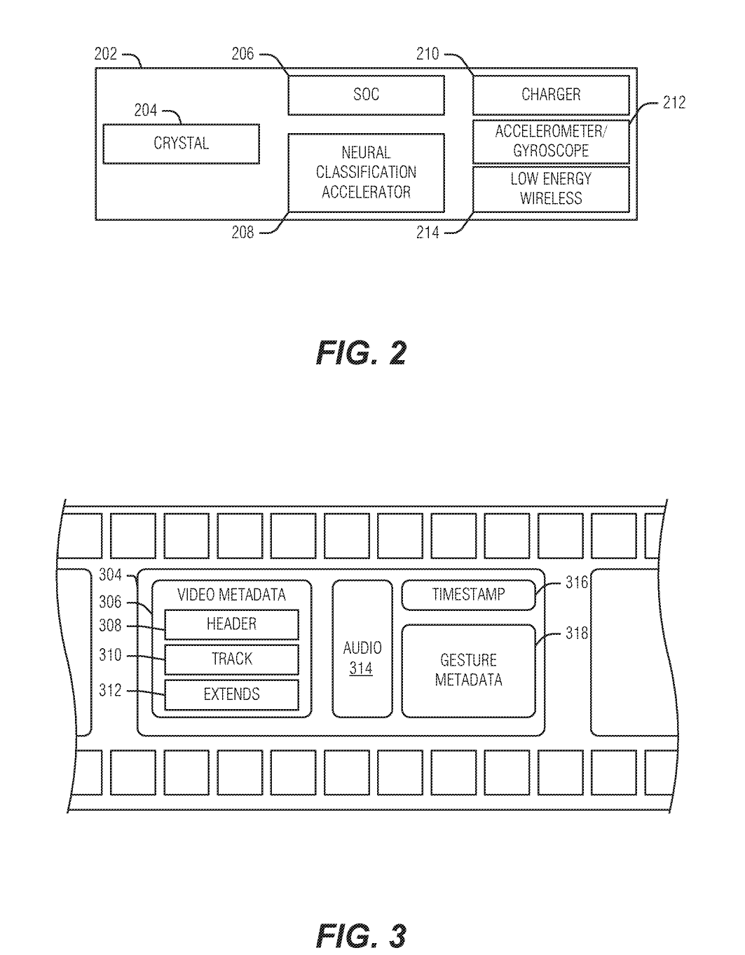

FIG. 2 illustrates a block diagram of an example of a device 202 to implement gesture embedded video, according to an embodiment. The device 202 may be used to implement the sensor 115 described above with respect to FIG. 1. As illustrated, the device 202 is a sensor processing package to be integrated into other computer hardware. The device 202 includes a system on a chip (SOC) 206 to address general computing tasks, an internal clock 204, a power source 210, and a wireless transceiver 214. The device 202 also includes a sensor array 212, which may include one or more of an accelerometer, gyroscope (e.g., gyrometer), barometer, or thermometer.

The device 202 may also include a neural classification accelerator 208. The neural classification accelerator 208 implements a set of parallel processing elements to address the common but numerous tasks often associated with artificial neural network classification techniques. In an example, the neural classification accelerator 208 includes a pattern matching hardware engine. The pattern matching engine implements patterns, such as a sensor classifier, to process or classify sensor data. In an example, the pattern matching engine is implemented via a parallelized collection of hardware elements that each match a single pattern. In an example, the collection of hardware elements implement an associative array, the sensor data samples providing keys to the array when a match is present.

FIG. 3 illustrates an example of a data structure 304 to encode gesture data with a video, according to an embodiment. The data structure 304 is a frame-based data structure as opposed to, for example, the library, table, or header-based data structure described above. Thus, the data structure 304 represents a frame in encoded video. The data structure 304 includes video metadata 306, audio information 314, a timestamp 316, and gesture metadata 318. The video metadata 306 contains typical information about the frame, such as a header 308, track 310, or extends (e.g., extents) 312. Aside from the gesture metadata 318, the components of the data structure 304 may vary from those illustrated according to a variety of video codecs. The gesture metadata 318 may contain one or more of a sensor sample set, a normalized sample set, a quantized sample set, an index, a label, or a model. Typically, however, for frame based gesture metadata, a compact representation of the gesture will be used, such as an index or label. In an example, the representation of the gesture may be compressed. In an example, the gesture metadata includes one or more additional fields to characterize the representation of the gesture. These fields may include some or all of a gesture type, a sensor identification of one or more sensors used to capture the sensor set, a bookmark type (e.g., beginning of bookmark, end of bookmark, an index of a frame within a bookmark), or an identification of a user (e.g., used to identify a user's personal sensor adjustments or to identify a user gesture library from a plurality of libraries).

Thus, FIG. 3 illustrates an example video file format to support gesture embedded video. The action gesture metadata 318 is an extra block that is parallel with the audio 314, timestamp 316, and movie 306 metadata blocks. In an example, the action gesture metadata block 318 stores motion data defined by the user and later used as a reference tag to locate parts of the video data, acting as a bookmark.

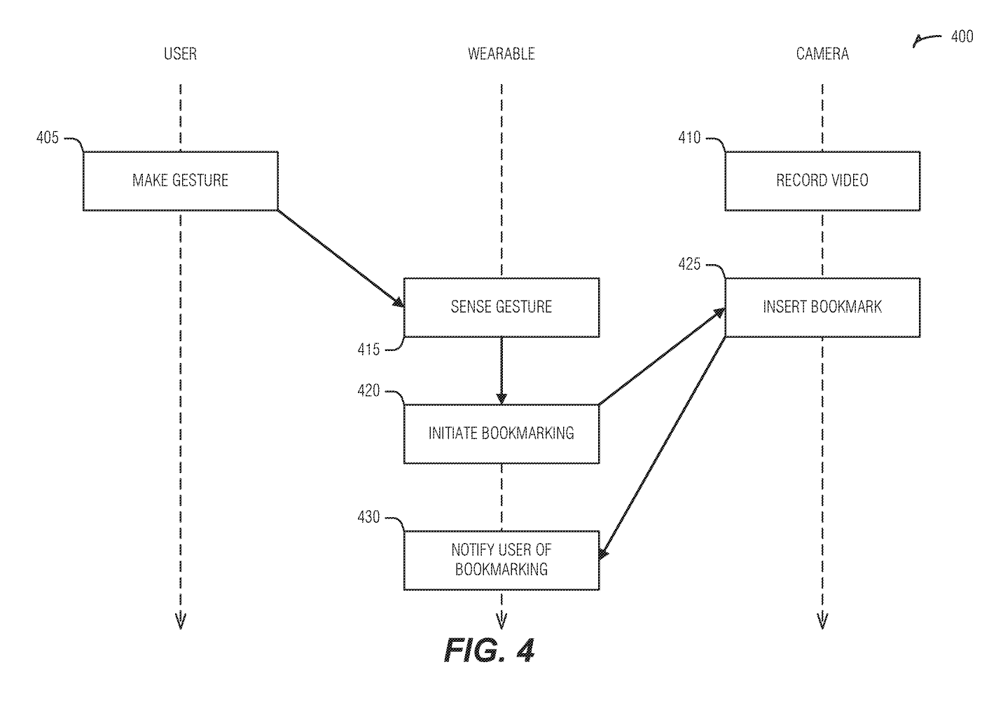

FIG. 4 illustrates an example of an interaction 400 between devices to encode gestures into video, according to an embodiment. The interaction 400 is between a user, a wearable of the user, such as a wrist worn device, and a camera that is capturing video. A scenario may include a user that is recording an ascent whilst mountain climbing. The camera is started to record video from just prior to the ascent (block 410) The user approaches a sheer face and plans to ascend via a crevasse. Not wanting to release her grip from a safety line, the user pumps her hand, with the wearable, up and down the line three times, conforming to a predefined gesture (block 405). The wearable senses (e.g., detects, classifies, etc.) the gesture (block 415) and matches the gesture to a predefined action gesture. The matching may be important as the wearable may perform non-bookmarking related tasks in response to gestures that are not designated as action gestures for the purposes of bookmarking video.

After determining that the gesture is a predefined action gesture, the wearable contacts the camera to indicate a bookmark (block 420). The camera inserts the bookmark (block 425) and responds to the wearable that the operation was successful and the wearable responds to the user with a notification (block 430), such as a beep, vibration, visual cue, etc.

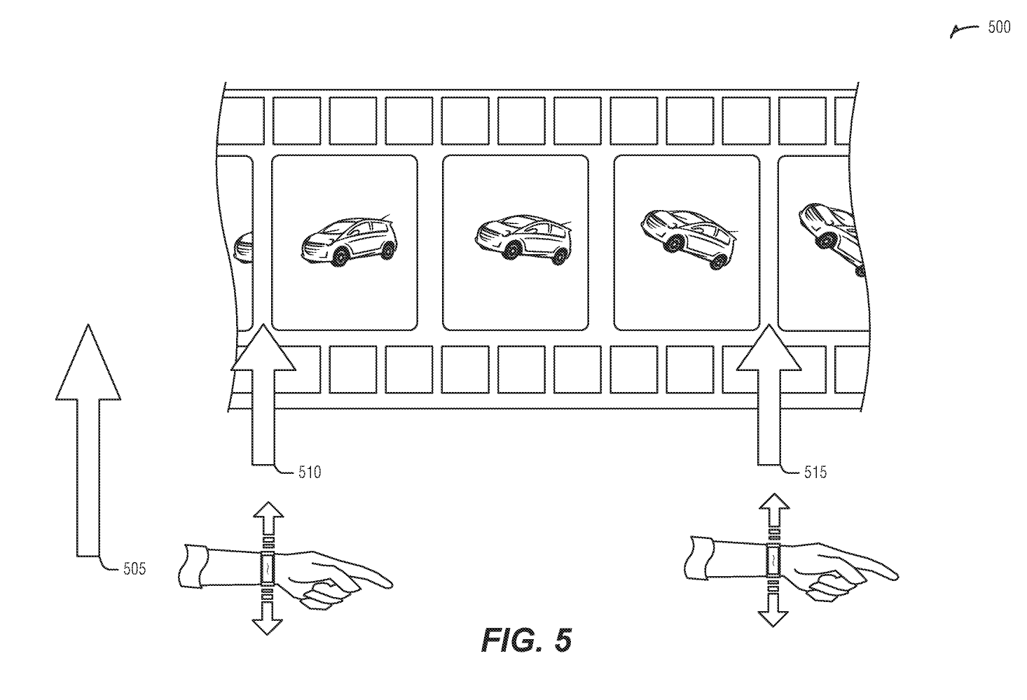

FIG. 5 illustrates an example of marking points in encoded video 500 with gestures, according to an embodiment. The video 500 is started (e.g., played) at point 505. The user makes a predefined action gesture during playback. The player recognizes the gesture and forwards (or reverses) the video to point 510. The user makes the same gesture again and the player now forwards to point 515. Thus, FIG. 5 illustrates the re-use of the same gesture to find points in the video 500 previously marked by the gesture. This allows, for example, the user to define one gesture, for example, to signal whenever his child is doing something interesting and another gesture to signal, for example, whenever his dog is doing something interesting in a day out at the park. Or, different gestures typically of a medical procedure may be defined and recognized during a surgery in which several procedures are used. In either case, the bookmarking may be classified by the gesture chosen, while all are still tagged.

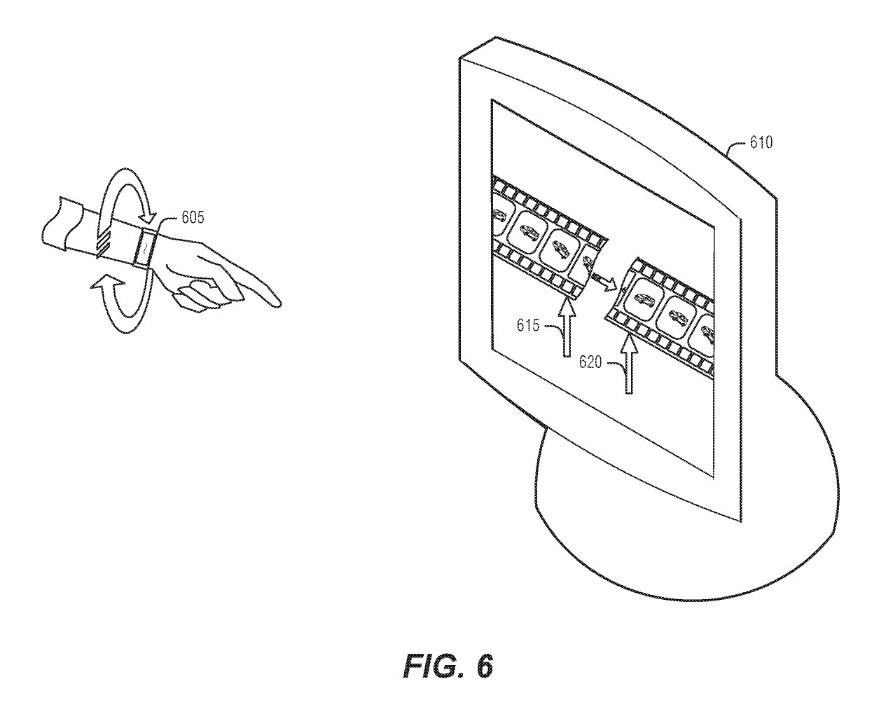

FIG. 6 illustrates an example of using gestures 605 with gesture embedded video as a user interface 610, according to an embodiment. Much like FIG. 5, FIG. 6 illustrates use of the gesture to skip from point 615 to point 620 while a video is being rendered on a display 610. In this example, the gesture metadata may identify the particular wearable 605 used to create the sample set, gesture, or representation of the gesture in the first place. In this example, one may consider the wearable 605 paired to the video. In an example, the same wearable 605 used to originally bookmark the video is required to perform the gesture lookup whilst the video is rendered.

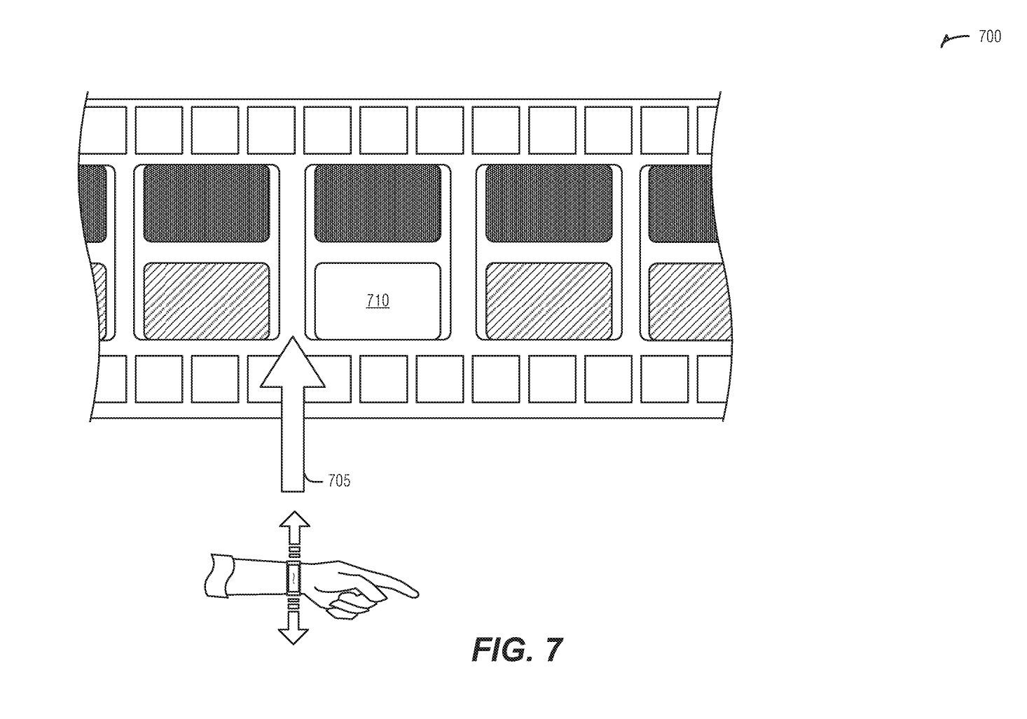

FIG. 7 illustrates an example of metadata 710 per-frame encoding of gesture data in encoded video 700, according to an embodiment. The darkly shaded components of the illustrated frames are video metadata. The lightly shaded components are gesture metadata. As illustrated, in a frame-based gesture embedding, when the user makes the recall gesture (e.g., repeats the gesture used to define a bookmark), the player seeks through the gesture metadata of the frames until it finds a match, here in gesture metadata 710 at point 705.

Thus, during playback, a smart wearable captures the motion of the user's hand. The motion data is compared and referred with the predefine action gesture metadata stack (lightly shaded components) to see if it matches one.

Once a match is obtained (e.g., at metadata 710), the action gesture metadata will be matched to the movie frame metadata that corresponds to it (e.g., in the same frame). Then, the video playback will immediately jump to the movie frame metadata that it was matched to (e.g., point 705), and the bookmarked video will begin.

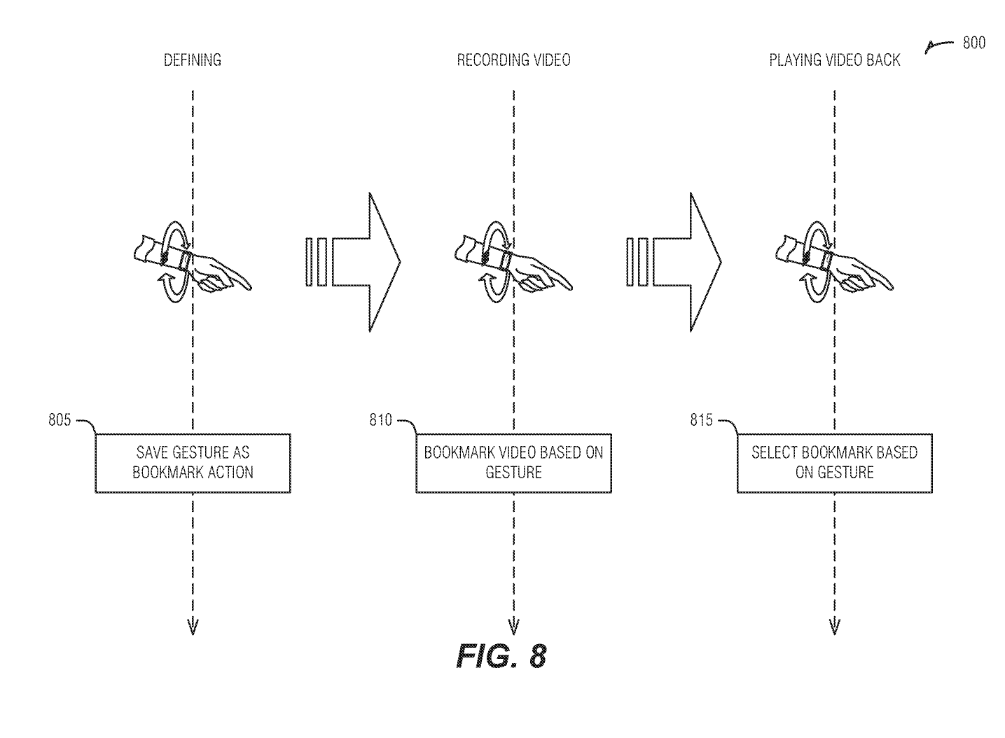

FIG. 8 illustrates an example life cycle 800 of using gestures with gesture embedded video, according to an embodiment. In the life cycle 800, the same hand action gesture is used in three separate stages.

In stage 1, the gesture is saved, or defined, as a bookmark action (e.g., predefined action gesture) at block 805. Here, the user performs the action whilst the system is in a training or recording mode and the system saves the action as a defined bookmark action.

In stage 2, a video is bookmarked while recording when the gesture is performed at block 810. Here, the user performs the action when he wishes to bookmark this part of the video while filming an activity.

In stage 3, a bookmark is selected from the video when the gesture is performed during playback at block 815. Thus, the same gesture that the user defines (e.g., user directed gesture use) is used to mark the video and then later to retrieve (e.g., identify, match, etc.) the marked portion of the video.

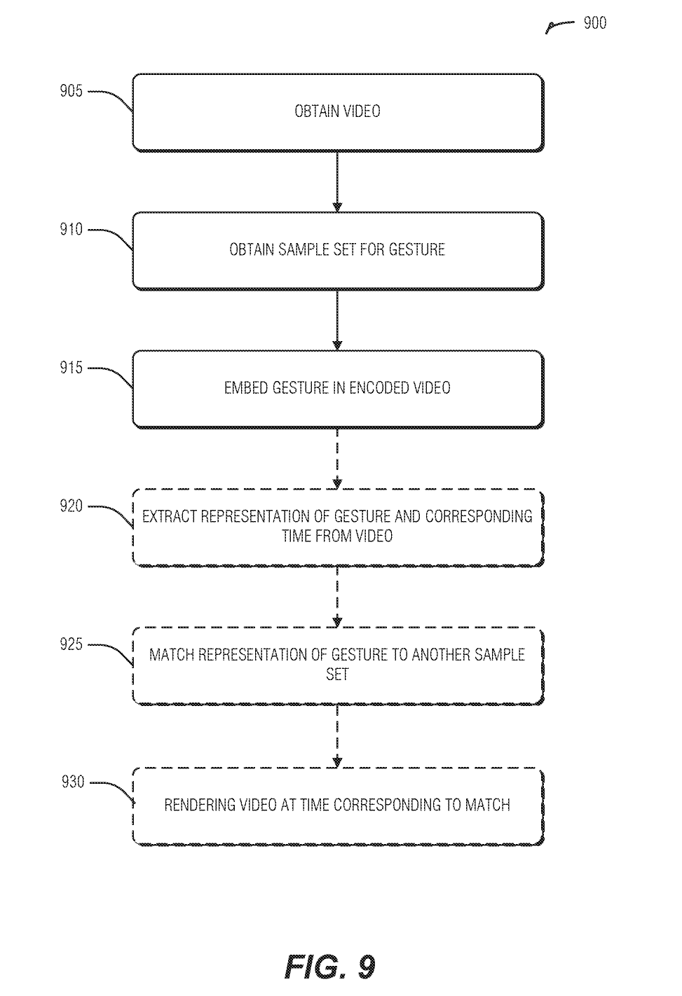

FIG. 9 illustrates an example of a method 900 to embed gestures in video, according to an embodiment. The operations of the method 900 are implemented in computer hardware, such as that described above with respect to FIGS. 1-8 or below with respect to FIG. 13 (e.g., circuitry, processors, etc.).

At operation 905, a video stream is obtained (e.g., by a receiver, transceiver, bus, interface, etc.).

At operation 910, a sensor is measured to obtain a sample set. In an example, members of the sample set are constituent to a gesture (e.g., the gesture is defined or derived from the data in the sample set). In an example, the sample set corresponds to a time relative to the video stream. In an example, the sensor is at least one of an accelerometer or a gyrometer. In an example, the sensor is in a first housing for a first device and wherein a receiver (or other device obtaining the video) and an encoder (or other device encoding the video) are in a second housing for a second device. In this example, the first device is communicatively coupled to the second device when both devices are in operation.

At operation 915, a representation of the gesture and the time is embedded (e.g., via a video encoder, encoder pipeline, etc.) in an encoded video of the video stream. In an example, the representation of the gesture is at least one of a normalized version of the sample set, a quantization of the members of the sample set, a label, an index, or a model. In an example, the model includes an input definition that provides sensor parameters for the model. In an example, the model provides a true or false output signaling whether the values for the input parameters represent the gesture.

In an example, embedding the representation of the gesture and the time (operation 915) includes adding a metadata data structure to the encoded video. In an example, the metadata data structure is a table with the representation of the gesture indicated in a first column and a corresponding time in a second column of the same row (e.g., they are in the same record). In an example, embedding the representation of the gesture and the time includes adding a metadata data structure to the encoded video, the data structure including a single entry encoding with a frame of the video. Thus, this example represents each frame of the video including a gesture metadata data structure.

The method 900 may be optionally extended with the illustrated operations 920, 925, and 930.

At operation 920, the representation of the gesture and the time is extracted from the encoded video. In an example, the gesture is one of a plurality of different gestures in the encoded video.

At operation 925, the representation of the gesture is matched to a second sample set obtained during rendering (e.g., playback, editing, etc.) of the video stream.

At operation 930, the video stream is rendered from the encoded video at the time in response to the match from the comparator. In an example, the gesture is one of a plurality of the same representation of the gesture encoded in the video. That is, the same gesture was used to make more than one mark in the video. In this example, the method 900 may track a number of times an equivalent of the second sample set was obtained (e.g., with a counter). The method 900 may then render the video at the selected the time based on the counter. For example, if the gesture was performed five times during playback, the method 900 would render the fifth occurrence of the gesture embedded in the video.

The method 900 may optionally be extended by the following operations:

An indication of a training set for a new gesture is received from a user interface. In response to receiving the indication, the method 900 may create a representation of a second gesture based on the training set (e.g., obtained from a sensor). In an example, the method 900 may also encode a library of gesture representations in the encoded video. Here, the library may include the gesture, the new gesture, and a gesture that does not have a corresponding time in the encoded video.

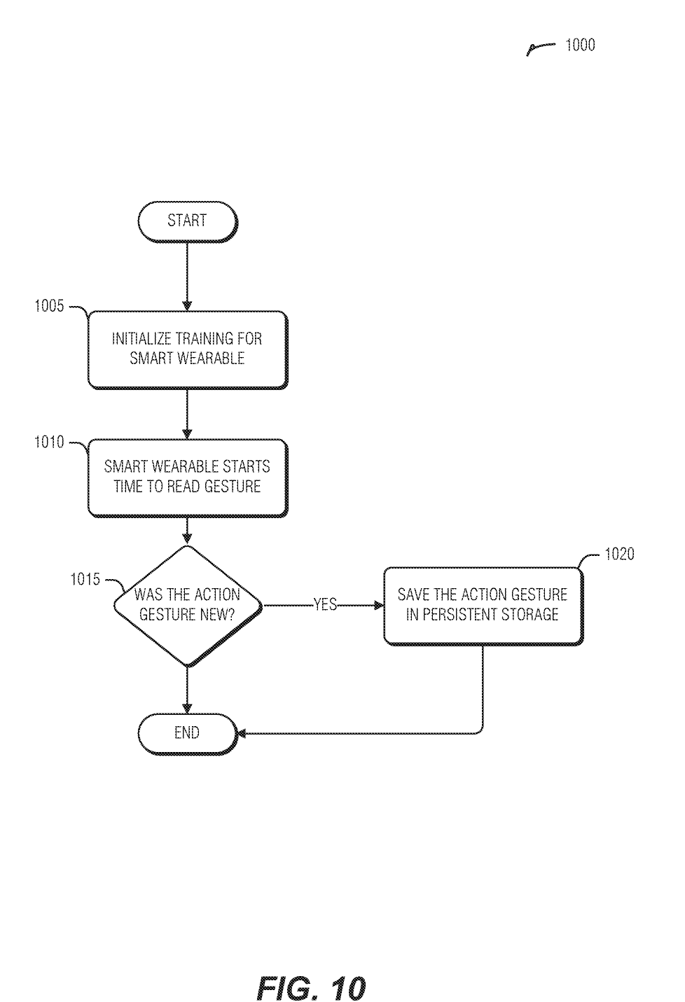

FIG. 10 illustrates an example of a method 1000 to add gestures to a repertoire of available gestures to embed during the creation of gesture embedded video, according to an embodiment. The operations of the method 1000 are implemented in computer hardware, such as that described above with respect to FIGS. 1-8 or below with respect to FIG. 13 (e.g., circuitry, processors, etc.). The method 1000) illustrates a technique to enter a gesture via a smart wearable with, for example, an accelerometer or gyrometer to plot hand gesture data. The smart wearable may be linked to an action camera.

The user may interact with a user interface, the interaction initializing training for the smart wearable (e.g., operation 1005). Thus, for example, the user may press start on the action camera to begin recording a bookmark pattern. The user then performs the hand gesture once in the duration of, for example, five seconds.

The smart wearable starts time to read the gesture (e.g., operation 1010). Thus, for example, the accelerometer data for the bookmark is recorded in response to the initialization for, for example, five seconds.

If the gesture was new (e.g., decision 1015), the action gesture is saved into persistent storage (e.g., operation 1020). In an example, the user may press a save button (e.g., the same or a different button than that used to initiate training) on the action camera to save the bookmark pattern metadata in smart wearable persistent storage.

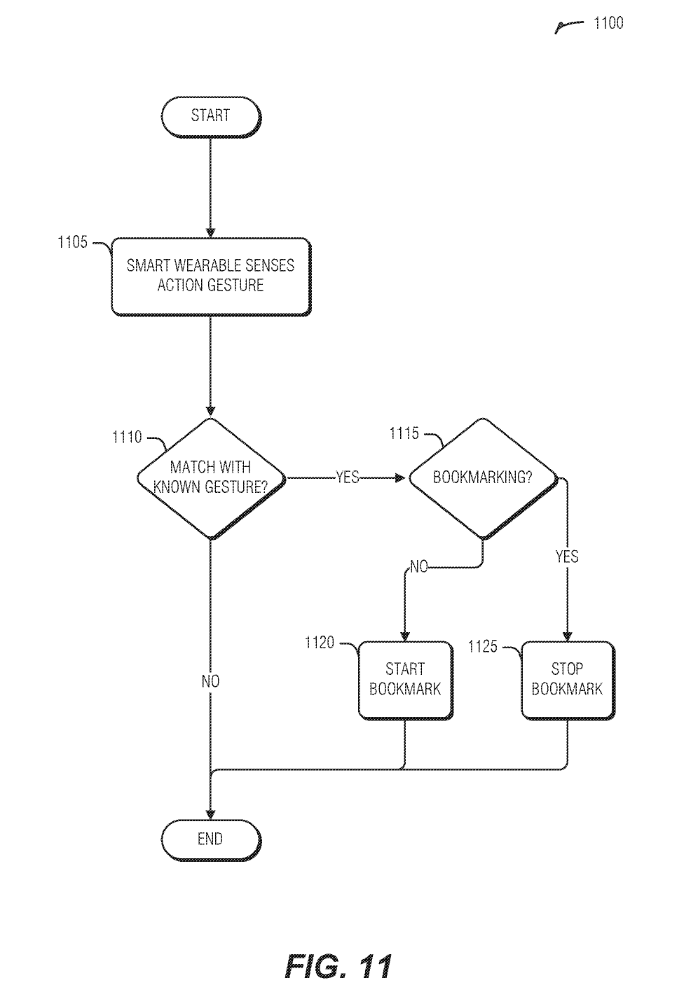

FIG. 11 illustrates an example of a method 1100 to add gestures to video, according to an embodiment. The operations of the method 1100 are implemented in computer hardware, such as that described above with respect to FIGS. 1-8 or below with respect to FIG. 13 (e.g., circuitry, processors, etc.). Method 1100 illustrates using a gesture to create a bookmark in the video.

The user does the predefined hand action gesture when the user thinks a cool action scene is about to come up. The smart wearable computes the accelerometer data and, once it detects a match in persistent storage, the smart wearable informs the action camera to begin the video bookmark event. This event chain proceeds as follows:

The wearable senses an action gesture made by a user (e.g., the wearable capture sensor data while the user makes the gesture) (e.g., operation 1105).

The capture sensor data is compared to predefined gestures in persistent storage (e.g., decision 1110). For example, the hand action gesture accelerometer data is checked to see if it matches a bookmark pattern.

If the captured sensor data does match a known pattern, the action camera may record the bookmark and, in an example, acknowledge the bookmark by, for example, instructing the smart wearable to vibrate once to indicate the beginning of video bookmarking. In an example, the bookmarking may operate on a state changing basis. In this example, the camera may check the state to determine whether bookmarking is in progress (e.g., decision 1115). If not, the bookmarking is started 1120.

After the user repeats the gesture, bookmarking is stopped if it was started (e.g., operation 1125). For example, after a particular cool action scene is done, the user performs the same hand action gesture used at the start to indicate a stop of bookmarking feature. Once a bookmark is complete, the camera may embedded the action gesture metadata in the video file associated with the time stamp.

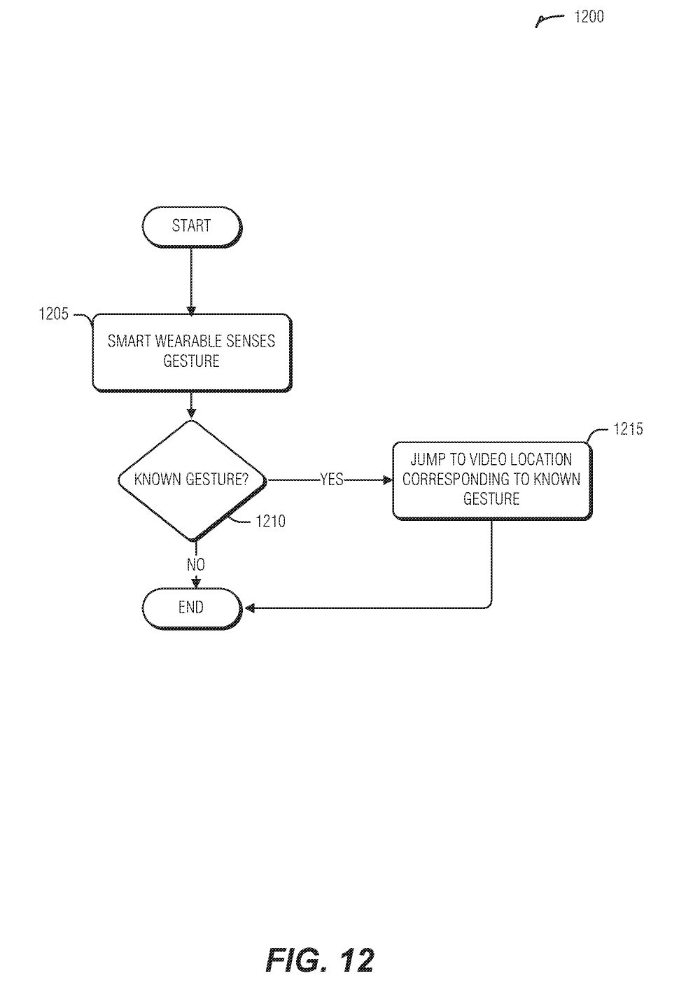

FIG. 12 illustrates an example of a method 1200 to use gestures embedded in video as a user interface element, according to an embodiment. The operations of the method 1200 are implemented in computer hardware, such as that described above with respect to FIGS. 1-8 or below with respect to FIG. 13 (e.g., circuitry, processors, etc.). The method 1200 illustrates using the gesture during video playback, editing, or other traversal of the video. In an example, the user must use the same wearable used to mark the video.

When the user wants to watch a particular bookmarked scene, all the user has to do is repeat the same hand action gesture used to mark the video. The wearable senses the gesture when the user performs the action (e.g., operation 1205).

If the bookmark pattern (e.g., gesture being performed by the user) matches with the accelerometer data saved in the smart wearables (e.g., decision 1210, the bookmark point will be located, and the users will jump to that point of the video footage (e.g., operation 1215).

If the user wishes to watch another piece of bookmarked footage, the user may perform the same gesture, or a different gesture, whichever corresponds to the desired bookmark, and the same process of the method 1200 will be repeated.

Using the systems and techniques described herein, users may use intuitive signaling to establish periods of interest in videos. These same intuitive signals are encoded in the video itself, allowing them to be used after the video is produced, such as during editing or playback. To recap some features described above: Smart wearables store predefined actions gesture metadata in the persistent storage; Video frame file format container consist of movie metadata, audio and action gesture metadata associated with time stamp; A hand action gesture to bookmark a video, user repeat the same hand action gesture to locate that bookmark; Different hand action gestures can be added to bookmark different segments of the video, making each bookmark tag distinct; and The same hand action gesture will trigger different events at the different stage. These elements provide the following solutions in example use cases introduced above:

For the extreme sports user: while it is difficult for users to press a button on the action camera itself, it will be fairly easy for them to wave their hand, or perform a sports action (e.g., swinging a tennis racket, hockey stick, etc.) for example during the sports activity. For example, the user may wave his hand before he intends to do a stunt. During playback, all the user has to do to view his stunt is to wave his hand again.

For law enforcement: a police officer might be in pursuit of a suspect, raise her gun during a shootout or might even fall to the ground when injured. These are all the possible gestures or movements that a police officer might make during a shift that may be used to bookmark video footage from a worn camera. Thus, these gestures may be predefined and used as bookmark tags. It will ease up the playback process since the film of an officer on duty may span many hours.

For medical professionals: doctors raise their hands a certain way during a surgery procedure. This motion may be distinct for different surgery procedures. These hand gestures may be predefined as bookmark gestures. For example, the motion of sewing a body part may be used as a bookmark tag. Thus, when the doctor intends to view the sewing procedure, all that is needed is to reenact the sewing motion and segment will be immediately viewable.

FIG. 13 illustrates a block diagram of an example machine 1300 upon which any one or more of the techniques (e.g., methodologies) discussed herein may perform. In alternative embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environment. The machine 1300 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 1300 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308. The machine 1300 may further include a display unit 1310, an alphanumeric input device 1312 (e.g., a keyboard), and a user interface (UI) navigation device 1314 (e.g., a mouse). In an example, the display unit 1310, input device 1312 and UI navigation device 1314 may be a touch screen display. The machine 1300 may additionally include a storage device (e.g., drive unit) 1316, a signal generation device 1318 (e.g., a speaker), a network interface device 1320, and one or more sensors 1321, such as a global positioning system (GPS) sensor, compass, accelerometer, or other sensor. The machine 1300) may include an output controller 1328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1316 may include a machine readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within static memory 1306, or within the hardware processor 1302 during execution thereof by the machine 1300. In an example, one or any combination of the hardware processor 1302, the main memory 1304, the static memory 1306, or the storage device 1316 may constitute machine readable media.

While the machine readable medium 1322 is illustrated as a single medium, the term “machine readable medium” may include a single medium or multiple media (e.g., a centralized or distributed database, and/or associated caches and servers) configured to store the one or more instructions 1324.

The term “machine readable medium” may include any medium that is capable of storing, encoding, or carrying instructions for execution by the machine 1300 and that cause the machine 1300 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device 1320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1320 may include one or more physical jacks (e.g., Ethernet, coaxial, or phone jacks) or one or more antennas to connect to the communications network 1326. In an example, the network interface device 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1300, and includes digital or analog communications signals or other intangible medium to facilitate communication of such software.

### ADDITIONAL NOTES & EXAMPLES

Example 1 is a system for embedded gesture in video, the system comprising: a receiver to obtain a video stream; a sensor to obtain a sample set, members of the sample set being constituent to a gesture, the sample set corresponding to a time relative to the video stream; and an encoder to embed a representation of the gesture and the time in an encoded video of the video stream.

In Example 2, the subject matter of Example 1 optionally includes wherein the sensor is at least one of an accelerometer or a gyrometer.

In Example 3, the subject matter of any one or more of Examples 1-2 optionally include wherein the representation of the gesture is at least one of a normalized version of the sample set, a quantization of the members of the sample set, a label, an index, or a model.

In Example 4, the subject matter of Example 3 optionally includes wherein the model includes an input definition that provides sensor parameters for the model, the model providing a true or false output signaling whether the values for the input parameters represent the gesture.

In Example 5, the subject matter of any one or more of Examples 1-4 optionally include wherein to embed the representation of the gesture and the time includes adding a metadata data structure to the encoded video.

In Example 6, the subject matter of Example 5 optionally includes wherein the metadata data structure is a table with the representation of the gesture indicated in a first column and a corresponding time in a second column of the same row.

In Example 7, the subject matter of any one or more of Examples 1-6 optionally include wherein to embed the representation of the gesture and the time includes adding a metadata data structure to the encoded video, the data structure including a single entry encoding with a frame of the video.

In Example 8, the subject matter of any one or more of Examples 1-7 optionally include a decoder to extract the representation of the gesture and the time from the encoded video; a comparator to match the representation of the gesture to a second sample set obtained during rendering of the video stream; and a player to render the video stream from the encoded video at the time in response to the match from the comparator.

In Example 9, the subject matter of Example 8 optionally includes wherein the gesture is one of a plurality of different gestures in the encoded video.

In Example 10, the subject matter of any one or more of Examples 8-9 optionally include wherein the gesture is one of a plurality of the same representation of the gesture encoded in the video, the system comprising a counter to track a number of times an equivalent of the second sample set was obtained, and wherein the player selected the time based on the counter.

In Example 11, the subject matter of any one or more of Examples 1-10 optionally include a user interface to receive indication of a training set for a new gesture; and a trainer to create a representation of a second gesture based on the training set, wherein the sensor obtains the training set in response to receipt of the indication.

In Example 12, the subject matter of Example 11 optionally includes wherein a library of gesture representations are encoded in the encoded video, the library including the gesture and the new gesture, and a gesture that does not have a corresponding time in the encoded video.

In Example 13, the subject matter of any one or more of Examples 1-12 optionally include wherein the sensor is in a first housing for a first device and where in the receiver and the encoder are in a second housing for a second device, the first device being communicatively coupled to the second device when both devices are in operation.

Example 14 is a method for embedded gesture in video, the method comprising: obtaining a video stream by a receiver; measuring a sensor to obtain a sample set, members of the sample set being constituent to a gesture, the sample set corresponding to a time relative to the video stream; and embedding, with an encoder, a representation of the gesture and the time in an encoded video of the video stream.

In Example 15, the subject matter of Example 14 optionally includes wherein the sensor is at least one of an accelerometer or a gyrometer.

In Example 16, the subject matter of any one or more of Examples 14-15 optionally include wherein the representation of the gesture is at least one of a normalized version of the sample set, a quantization of the members of the sample set, a label, an index, or a model.

In Example 17, the subject matter of Example 16 optionally includes wherein the model includes an input definition that provides sensor parameters for the model, the model providing a true or false output signaling whether the values for the input parameters represent the gesture.

In Example 18, the subject matter of any one or more of Examples 14-17 optionally include wherein embedding the representation of the gesture and the time includes adding a metadata data structure to the encoded video.

In Example 19, the subject matter of Example 18 optionally includes wherein the metadata data structure is a table with the representation of the gesture indicated in a first column and a corresponding time in a second column of the same row.

In Example 20, the subject matter of any one or more of Examples 14-19 optionally include wherein embedding the representation of the gesture and the time includes adding a metadata data structure to the encoded video, the data structure including a single entry encoding with a frame of the video.

In Example 21, the subject matter of any one or more of Examples 14-20 optionally include extracting the representation of the gesture and the time from the encoded video; matching the representation of the gesture to a second sample set obtained during rendering of the video stream; and rendering the video stream from the encoded video at the time in response to the match from the comparator.

In Example 22, the subject matter of Example 21 optionally includes wherein the gesture is one of a plurality of different gestures in the encoded video.

In Example 23, the subject matter of any one or more of Examples 21-22 optionally include wherein the gesture is one of a plurality of the same representation of the gesture encoded in the video, the method comprising: tracking a number of times an equivalent of the second sample set was obtained with a counter, and the rendering selected the time based on the counter.

In Example 24, the subject matter of any one or more of Examples 14-23 optionally include receiving an indication of a training set for a new gesture from a user interface; and creating, in response to receipt of the indication, a representation of a second gesture based on the training set.

In Example 25, the subject matter of Example 24 optionally includes encoding a library of gesture representations in the encoded video, the library including the gesture, the new gesture, and a gesture that does not have a corresponding time in the encoded video.

In Example 26, the subject matter of any one or more of Examples 14-25 optionally include wherein the sensor is in a first housing for a first device and wherein the receiver and the encoder are in a second housing for a second device, the first device being communicatively coupled to the second device when both devices are in operation.

Example 27 is a system comprising means to implement any of methods 14-26.

Example 28 is at least one machine readable medium including instructions that, when executed by a machine, cause the machine to perform any of methods 14-26.

Example 29 is a system for embedded gesture in video, the system comprising: means for obtaining a video stream by a receiver; means for measuring a sensor to obtain a sample set, members of the sample set being constituent to a gesture, the sample set corresponding to a time relative to the video stream; and means for embedding, with an encoder, a representation of the gesture and the time in an encoded video of the video stream.

In Example 30, the subject matter of Example 29 optionally includes wherein the sensor is at least one of an accelerometer or a gyrometer.

In Example 31, the subject matter of any one or more of Examples 29-30 optionally include wherein the representation of the gesture is at least one of a normalized version of the sample set, a quantization of the members of the sample set, a label, an index, or a model.

In Example 32, the subject matter of Example 31 optionally includes wherein the model includes an input definition that provides sensor parameters for the model, the model providing a true or false output signaling whether the values for the input parameters represent the gesture.

In Example 33, the subject matter of any one or more of Examples 29-32 optionally include wherein the means for embedding the representation of the gesture and the time includes means for adding a metadata data structure to the encoded video.

In Example 34, the subject matter of Example 33 optionally includes wherein the metadata data structure is a table with the representation of the gesture indicated in a first column and a corresponding time in a second column of the same row.

In Example 35, the subject matter of any one or more of Examples 29-34 optionally include wherein the means for embedding the representation of the gesture and the time includes means for adding a metadata data structure to the encoded video, the data structure including a single entry encoding with a frame of the video.

In Example 36, the subject matter of any one or more of Examples 29-35 optionally include means for extracting the representation of the gesture and the time from the encoded video; means for matching the representation of the gesture to a second sample set obtained during rendering of the video stream; and means for rendering the video stream from the encoded video at the time in response to the match from the comparator.

In Example 37, the subject matter of Example 36 optionally includes wherein the gesture is one of a plurality of different gestures in the encoded video.

In Example 38, the subject matter of any one or more of Examples 36-37 optionally include wherein the gesture is one of a plurality of the same representation of the gesture encoded in the video, the system comprising: means for tracking a number of times an equivalent of the second sample set was obtained with a counter, and the rendering selected the time based on the counter.

In Example 39, the subject matter of any one or more of Examples 29-38 optionally include means for receiving an indication of a training set for a new gesture from a user interface; and means for creating, in response to receipt of the indication, a representation of a second gesture based on the training set.

In Example 40, the subject matter of Example 39 optionally includes means for encoding a library of gesture representations in the encoded video, the library including the gesture, the new gesture, and a gesture that does not have a corresponding time in the encoded video.

In Example 41, the subject matter of any one or more of Examples 29-40 optionally include wherein the sensor is in a first housing for a first device and wherein the receiver and the encoder are in a second housing for a second device, the first device being communicatively coupled to the second device when both devices are in operation.

Example 42 is at least one machine readable medium including instructions for embedded gesture in video, the instructions, when executed by a machine, cause the machine to: obtain a video stream; obtain a sample set, members of the sample set being constituent to a gesture, the sample set corresponding to a time relative to the video stream; and embed a representation of the gesture and the time in an encoded video of the video stream.

In Example 43, the subject matter of Example 42 optionally includes wherein the sensor is at least one of an accelerometer or a gyrometer.

In Example 44, the subject matter of any one or more of Examples 42-43 optionally include wherein the representation of the gesture is at least one of a normalized version of the sample set, a quantization of the members of the sample set, a label, an index, or a model.

In Example 45, the subject matter of Example 44 optionally includes wherein the model includes an input definition that provides sensor parameters for the model, the model providing a true or false output signaling whether the values for the input parameters represent the gesture.

In Example 46, the subject matter of any one or more of Examples 42-45 optionally include wherein to embed the representation of the gesture and the time includes adding a metadata data structure to the encoded video.

In Example 47, the subject matter of Example 46 optionally includes wherein the metadata data structure is a table with the representation of the gesture indicated in a first column and a corresponding time in a second column of the same row.

In Example 48, the subject matter of any one or more of Examples 42-47 optionally include wherein to embed the representation of the gesture and the time includes adding a metadata data structure to the encoded video, the data structure including a single entry encoding with a frame of the video.

In Example 49, the subject matter of any one or more of Examples 42-48 optionally include wherein the instructions cause the machine to: extract the representation of the gesture and the time from the encoded video; match the representation of the gesture to a second sample set obtained during rendering of the video stream; and render the video stream from the encoded video at the time in response to the match from the comparator.

In Example 50, the subject matter of Example 49 optionally includes wherein the gesture is one of a plurality of different gestures in the encoded video.

In Example 51, the subject matter of any one or more of Examples 49-50 optionally include wherein the gesture is one of a plurality of the same representation of the gesture encoded in the video, the instructions cause the machine to implement a counter to track a number of times an equivalent of the second sample set was obtained, and wherein the player selected the time based on the counter.

In Example 52, the subject matter of any one or more of Examples 42-51 optionally include wherein the instructions cause the machine to: implement a user interface to receive indication of a training set for a new gesture, and to create a representation of a second gesture based on the training set, wherein the sensor obtains the training set in response to receipt of the indication.

In Example 53, the subject matter of Example 52 optionally includes wherein a library of gesture representations are encoded in the encoded video, the library including the gesture and the new gesture, and a gesture that does not have a corresponding time in the encoded video.

In Example 54, the subject matter of any one or more of Examples 42-53 optionally include wherein the sensor is in a first housing for a first device and where in the receiver and the encoder are in a second housing for a second device, the first device being communicatively coupled to the second device when both devices are in operation.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-25. (canceled)

26. A system for embedded gesture in video, the system comprising:
a receiver to obtain a video stream;
a sensor to obtain a sample set, members of the sample set being constituent to a gesture, the sample set corresponding to a time relative to the video stream; and
an encoder to embed a representation of the gesture and the time in an encoded video of the video stream.

27. The system of claim 26, wherein the representation of the gesture is at least one of a normalized version of the sample set, a quantization of the members of the sample set, a label, an index, or a model.

28. The system of claim 27, wherein the model includes an input definition that provides sensor parameters for the model, the model providing a true or false output signaling whether the values for the input parameters represent the gesture.

29. The system of claim 26, wherein to embed the representation of the gesture and the time includes adding a metadata data structure to the encoded video.

30. The system of claim 26, comprising:
a decoder to extract the representation of the gesture and the time from the encoded video;
a comparator to match the representation of the gesture to a second sample set obtained during rendering of the video stream; and
a player to render the video stream from the encoded video at the time in response to the match from the comparator.

31. The system of claim 30, wherein the gesture is one of a plurality of different gestures in the encoded video.

32. The system of claim 30, wherein the gesture is one of a plurality of the same representation of the gesture encoded in the video, the system comprising a counter to track a number of times an equivalent of the second sample set was obtained, and wherein the player selected the time based on the counter.

33. The system of claim 26, comprising:
a user interface to receive indication of a training set for a new gesture; and
a trainer to create a representation of a second gesture based on the training set, wherein the sensor obtains the training set in response to receipt of the indication.

34. A method for embedded gesture in video, the method comprising:
obtaining a video stream by a receiver;
measuring a sensor to obtain a sample set, members of the sample set being constituent to a gesture, the sample set corresponding to a time relative to the video stream; and
embedding, with an encoder, a representation of the gesture and the time in an encoded video of the video stream.

35. The method of claim 34, wherein the representation of the gesture is at least one of a normalized version of the sample set, a quantization of the members of the sample set, a label, an index, or a model.

36. The method of claim 35, wherein the model includes an input definition that provides sensor parameters for the model, the model providing a true or false output signaling whether the values for the input parameters represent the gesture.

37. The method of claim 34, wherein embedding the representation of the gesture and the time includes adding a metadata data structure to the encoded video.

38. The method of claim 34, comprising:
extracting the representation of the gesture and the time from the encoded video;
matching the representation of the gesture to a second sample set obtained during rendering of the video stream; and
rendering the video stream from the encoded video at the time in response to the match from the comparator.

39. The method of claim 38, wherein the gesture is one of a plurality of different gestures in the encoded video.

40. The method of claim 38, wherein the gesture is one of a plurality of the same representation of the gesture encoded in the video, the method comprising:
tracking a number of times an equivalent of the second sample set was obtained with a counter, and the rendering selected the time based on the counter.

41. The method of claim 34, comprising:
receiving an indication of a training set for a new gesture from a user interface; and
creating, in response to receipt of the indication, a representation of a second gesture based on the training set.

42. At least one machine readable medium including instructions for embedded gesture in video, the instructions, when executed by a machine, cause the machine to:
obtain a video stream;
obtain a sample set, members of the sample set being constituent to a gesture, the sample set corresponding to a time relative to the video stream; and
embed a representation of the gesture and the time in an encoded video of the video stream.

43. The at least one machine readable medium of claim 42, wherein the representation of the gesture is at least one of a normalized version of the sample set, a quantization of the members of the sample set, a label, an index, or a model.

44. The at least one machine readable medium of claim 43, wherein the model includes an input definition that provides sensor parameters for the model, the model providing a true or false output signaling whether the values for the input parameters represent the gesture.

45. The at least one machine readable medium of claim 42, wherein to embed the representation of the gesture and the time includes adding a metadata data structure to the encoded video.

46. The at least one machine readable medium of claim 42, wherein the instructions cause the machine to:
extract the representation of the gesture and the time from the encoded video;
match the representation of the gesture to a second sample set obtained during rendering of the video stream; and
render the video stream from the encoded video at the time in response to the match from the comparator.

47. The at least one machine readable medium of claim 46, wherein the gesture is one of a plurality of different gestures in the encoded video.

48. The at least one machine readable medium of claim 46, wherein the gesture is one of a plurality of the same representation of the gesture encoded in the video, the instructions cause the machine to implement a counter to track a number of times an equivalent of the second sample set was obtained, and wherein the player selected the time based on the counter.

49. The at least one machine readable medium of claim 42, wherein the instructions cause the machine to:
implement a user interface to receive indication of a training set for a new gesture, and
to create a representation of a second gesture based on the training set, wherein the sensor obtains the training set in response to receipt of the indication.
